(19) United States
(12) Patent Application Publication
(10) Pub. No.: US 2004/0090176 A1
(43) Pub. Date: May 13, 2004

(54) Organic electroluminescent panel, electrode substrate and method for manufacturing the electrode substrate

(76) Inventors: Yu-Kai Han, Taipei (TW); Hsia-Tsai Hsiao, Miaoli (TW); Ming-Chung Shih, Dali City (TW)

Correspondence Address: BIRCH STEWART KOLASCH & BIRCH, PO BOX 747, FALLS CHURCH, VA, 22040-0747, US

(21) Appl. No.: 10/691,563

(22) Filed: Oct. 24, 2003

(30) Foreign Application Priority Data
Oct. 25, 2002 (TW) 091125338

(51) Int. Cl. H01J 1/62

(52) U.S. Cl. 313/504

(57) ABSTRACT

An organic electroluminescent panel includes a substrate, a first electrode, a pixel-defining layer, an organic functional layer, and a second electrode. In this case, the first electrode is formed on one side of the substrate, and the pixel-defining layer is formed on the first electrode or on the substrate. A sidewall of the pixel-defining layer has a pattern with variant heights. The organic functional layer is formed between portions of the pixel-defining layer and is positioned on the first electrode. The second electrode is formed on the organic functional layer. Furthermore, an electrode substrate for constructing the panel and a method for manufacturing the electrode substrate are disclosed.

### BACKGROUND OF THE INVENTION

1. Field of Invention

The invention relates to a panel, electrode substrate and its manufacturing method and, in particular, to an organic electroluminescent panel, electrode substrate of the organic electroluminescent panel and manufacturing method thereof.

2. Related Art

Organic electroluminescent displays, generally including organic electroluminescent panels and organic electroluminescent devices, use the self-emission feature of an organic functional material to achieve the object of displaying.

In the manufacturing processes of full color organic electroluminescent devices, especially the polymer organic electroluminescent devices (PLEDs), dispensing organic functional materials for emitting three primary colors separately is the most preferred manufacturing method. Spin coating and ink-jet printing methods are in common employed to dispense the organic functional materials. In particular, the ink-jet printing is one of the popular processes for forming the organic functional layer of the PLED. The ink-jet printing possesses many advantages while forming the organic functional layer. Firstly, photomasks or screens are unnecessary, and the ink-jet printing can perform only one step to print the organic functional layer into any needed patterns, such as characters or irregular complicated patterns. The printed patterns can broaden the applications of the organic electroluminescent displays and decrease the time spend from design to production.

Secondly, in the ink-jet printing process, only the steps like alignment, ink-jet printing, and curing are needed, and it is unnecessary to subsequent steps like stripping and development. Therefore, it doesn't have to use developer and stripper, which can decrease the environment protecting problems. Thirdly, the equipments used in the ink-jet printing process are retrenched, so that the efficiency of material is high, and the production cycle time is shortened, resulting in decrease of the manufacturing cost.

In the ink-jet printing process, a print head (not shown) ejects the polymer organic functional material (ink droplet 4) onto the first electrode surface within a pixel to form the organic functional layer. Referring to FIG. 1, the conventional organic electroluminescent panel includes a substrate 11, a first electrode 12, and a pixel-defining layer 13. The sidewall of the pixel-defining layer 13 usually has a smooth surface of sidewalls. In the ink-jet printing process, when the droplet 4 is ejected to the surface of the first electrode 12 to form the organic functional layer 13, the droplet 4 has a high speed, which makes the droplet 4 splashing and fluctuation. As a result, not only overflowing will happen but also make the organic functional layer with bad uniformity.

Although the ink-jet printing method has previously-mentioned advantages, it still has the disadvantages as described herein below: a) the polymer organic functional material is un-uniformly distributed in the pixel area; and b) when the polymer organic functional material is ejected from the print head onto the pixel area, other nearby pixels will be contaminated by the splashing droplets. Both of the two disadvantages are the bottlenecks of the ink-jet printing process. Therefore, it is important to provide a method for manufacturing an electrode substrate or organic electroluminescent device for solving the above-mentioned problems.

### SUMMARY OF THE INVENTION

In the view of the foregoing, an objective of the invention is to provide an electrode substrate and a method for manufacturing the electrode substrate, which can prevent ink droplets from splashing and fluctuation after ejected.

It is another of the invention to provide an organic electroluminescent panel, which has an organic functional layer of high uniformity.

To achieve the above-mentioned objectives, an electrode substrate of the invention includes a substrate, a first electrode, and a pixel-defining layer. In the invention, the first electrode is formed on one side of the substrate. The pixel-defining layer with sidewalls is formed on the first electrode or on the substrate so as to form a pixel area.

Moreover, to achieve the above-mentioned objectives, the invention provides an organic electroluminescent panel, which includes a substrate, a first electrode, a pixel-defining layer, an organic functional layer, and a second electrode. In this aspect, the first electrode is formed on one side of the substrate. The pixel-defining layer with waved sidewalls is formed on the first electrode or on the substrate. The organic functional layer is formed on the first electrode. The second electrode is formed on the organic functional layer. The invention is characterized in that the pixel-defining layer has waved sidewalls. The waved pattern formed on the sidewall can prevent the ejected droplet of organic functional material from splashing and fluctuation effectively, resulting in the formation of a high uniform organic functional layer.

As described above, since the waved sidewall of the pixel-defining layer has a pattern with waved surfaces for increasing the contact area, the adhesion force between the ink droplet and the pixel-defining layer is increased, and the cohesion force of the droplet on the first electrode is decreased. Thus, when the ink droplet is ejected onto the electrode substrate, the splashing and fluctuation of the ejected organic functional material can be prevented. Moreover, the pixel-defining layer of the organic electroluminescent panel has a pattern with waved sidewalls, so the droplet splashing is decreased when forming the organic functional layer. Accordingly, the uniformity of the organic functional layer is increased.

### BRIEF DESCRIPTION OF THE DRAWINGS

The invention will become more fully understood from the detailed description given herein below illustrations only, and thus are not limitative of the present invention, and wherein:

FIG. 1 is a schematic three-dimensional view of the pixel area of the conventional electrode substrate;

FIG. 2 is a schematic three-dimensional view of a pixel area of an electrode substrate according to an embodiment of the invention, wherein the pattern of the waved sidewall of the pixel-defining layer includes a plurality of stripes parallel to the substrate;

FIG. 3 is a schematic three-dimensional view of a pixel area of the electrode substrate according to an embodiment of the invention, wherein the pattern of the waved sidewall of the pixel-defining layer includes a plurality of strips perpendicular to the substrate;

FIG. 4 is a schematic three-dimensional view of a pixel area of the electrode substrate according to an embodiment of the invention, wherein the pattern of the waved sidewall of the pixel-defining layer includes a plurality of protrusions;

FIG. 5 is a schematic three-dimensional view of a pixel area of the organic electroluminescent panel according to an embodiment of the invention; and

FIG. 6 is a schematic three-dimensional view of a pixel area of the organic electroluminescent panel according to another embodiment of the invention.

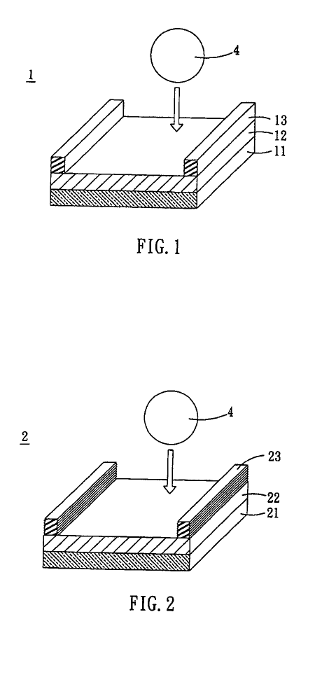

### DETAILED DESCRIPTION OF THE INVENTION

The electrode substrate, method for manufacturing the electrode substrate, and organic electroluminescent panel according to preferred embodiments of the invention will be described herein below with reference to the accompanying drawings, wherein the same reference numbers refer to the same elements.

The electrode substrate and the method for manufacturing the electrode substrate according to the preferred embodiments of the invention are described with reference to FIG. 2 to FIG. 4. In the invention, the organic functional material includes small molecular organic functional materials and polymer organic functional materials.

As shown in FIG. 2, the electrode substrate 2 of the invention includes a substrate 21, a first electrode 22, and a pixel-defining layer 23. In the present embodiment, the substrate 21 is a transparent substrate and can be a flexible or rigid substrate. The substrate can also be a plastic or glass substrate. In particular, the flexible substrate or plastic substrate can be made of polycarbonate (PC), polyester (PET), cyclic olefin copolymer (COC), or metallocene-based cyclic olefin copolymer (mCOC).

The first electrode 22 is formed on a surface of the substrate 21. In the present embodiment, the first electrode 22 is formed on the substrate by way of a sputtering method or an ion plating method. The first electrode 22 is usually used as a transparent anode and made of a conductive metal oxide, such as indium-tin oxide (ITO), aluminum-zinc oxide (AZO), or indium-zinc oxide (IZO). The thickness of the first electrode is about above 500 Å.

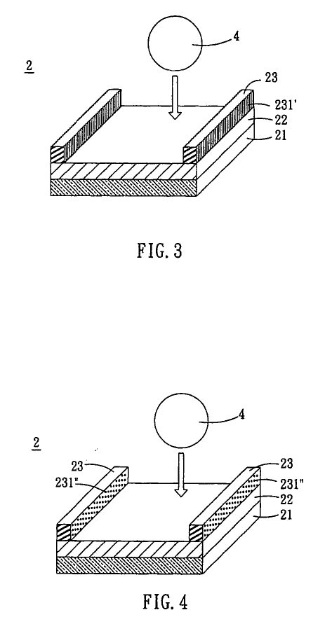

The pixel-defining layer 23 is formed on the first electrode 22 or on the substrate 21, and defines a plurality of pixel areas (FIG. 2 shows a single pixel area). The waved sidewall of the pixel-defining layer 23 has a pattern 231 with variant heights. The pattern 231 of the pixel-defining layer 23 can be saw-toothed, undulated or irregular, and is parallel to the substrate 21. The pattern 231′ of the sidewall of the pixel-defining layer 23 includes a plurality of stripes perpendicular to the substrate 21 as shown in FIG. 3. As shown in FIG. 4, the pattern 231″ includes a plurality of protrusions, which are irregular shape. The pixel-defining layer 23 is made of non-conductive material and is formed by exposure and development processes.

The method for manufacturing the electrode substrate is then described in more details herein below.

The method for manufacturing the electrode substrate according to an embodiment of the invention includes a first electrode forming process and a pixel-defining layer forming process. As shown in FIG. 2, in the first electrode forming process, the first electrode 22 is formed on the substrate 21 and the pixel-defining layer 23 is then formed by exposure and development method. In details, during the exposure treatment, when the light beam irradiates the pixel-defining layer 23, which is a photoresist, the light beam goes through the air and the pixel-defining layer, and reaches the substrate. The light beam will be reflected by the substrate, which results in constructive interference and destructive interference so as to form a standing wave effect in the pixel-defining layer 23. After the exposure treatment, the profile of the sidewall of the pixel-defining layer 23 is defined into an undulated pattern or a saw-toothed pattern. In the present invention, the material of the pixel-defining layer 23 can be photosensitive polyimide or photosensitive diazonaphtho-quinone-phenolic resin. The developer of the development is basic.

As described above, the pattern of the sidewall of the pixel-defining layer 23 can buffer the fluctuation caused by the droplet 4 ejected to the first electrode 22 in the pixel area, decrease the droplet splashing of the organic functional layer and prevent the nearby pixels from contamination. Furthermore, the pattern not only increase the contact area and improve the adhesion force between the ink droplet 4 and the pixel-defining layer 23, but also lower the cohesion force of the droplet 4 ejected to the first electrode 22. As a result, it can improve the uniformity of the organic functional layer and the production yield.

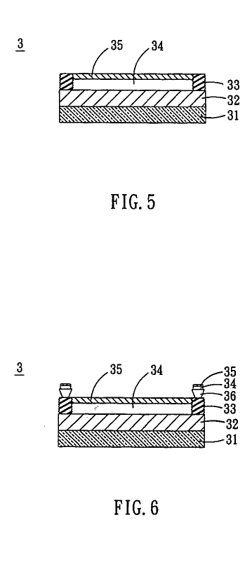

With reference to FIG. 5 and FIG. 6, the organic electroluminescent panel 3 according to a preferred embodiment of the invention is disclosed.

As shown in FIG. 5, the organic electroluminescent panel 3 includes a substrate 31, a first electrode 32, a pixel-defining layer 33, an organic functional layer 34 and a second electrode 35. In this embodiment, the first electrode 32 is formed on a surface of the substrate 31.

The pixel-defining layer 33 is formed on the first electrode 32 or on the substrate 31 and forms a plurality of pixel areas (FIG. 4 shows a single pixel area). The waved sidewall of the pixel-defining layer 33 has a pattern with variant heights. The pattern of the pixel-defining layer 33 can be saw-toothed, undulated or irregular. Besides, the pixel-defining layer 33 is made of a non-conductive material and formed by exposure and development processes. The method for forming the pattern of the sidewall of the pixel-defining layer 33 is the same as those previously mentioned.

The organic functional layer 34 is formed between portions of the pixel-defining layer 33, which define the pixel area. The second electrode 35 is formed on the organic functional layer 34.

Referring to FIG. 6, the organic electroluminescent panel 3 can further include a separator 36, which is formed on the pixel-defining layer 33.

As described above, in the present embodiment, the functions of the pattern formed on the waved sidewall of the pixel-defining layer 33 are to buffer the fluctuation caused by the droplets 4 ejected onto the first electrode 32 in the pixel area, to decrease the droplet splashing of the organic functional layer, and to prevent the nearby pixels from contamination. Furthermore, the patterns not only increase the contact area and improve the adhesion force between the ink droplet and the pixel-defining layer, but also lower the cohesion force of the droplet ejected onto the first electrode. As a result, the uniformity of the organic functional layer 34 can be improved.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. An electrode substrate, comprising:
a substrate;
a first electrode disposed on the substrate; and
a pixel-defining layer with waved sidewalls disposed on the first electrode or on the substrate.

2. The electrode substrate of claim 1, wherein the substrate is at least one selected from the group consisting of a glass substrate, a plastic substrate, and a flexible substrate.

3. The electrode substrate of claim 1, wherein the first electrode is a conductive metal oxide electrode.

4. The electrode substrate of claim 1, wherein the first electrode is at least one selected from the group consisting of an indium-tin oxide (ITO) electrode and an aluminum-zinc oxide (AZO) electrode.

5. The electrode substrate of claim 1, wherein the pixel-defining layer is made of a non-conductive material.

6. The electrode substrate of claim 5, wherein the pixel-defining layer is a photoresist.

7. The electrode substrate of claim 6, wherein the photoresist is photosensitive polyimide.

8. The electrode substrate of claim 6, wherein the photoresist is photosensitive diazonaphtho-quinone-phenolic resin.

9. A method for manufacturing an electrode substrate, comprising:
forming a first electrode on a substrate; and
forming a pixel-defining layer with waved sidewalls on the first electrode or on the substrate.

10. The method of claim 9, wherein the substrate is at least one selected from the group consisting of a glass substrate, a plastic substrate, and a flexible substrate.

11. The method of claim 9, wherein the first electrode is conductive metal oxide electrode.

12. The method of claim 92, wherein the pixel-defining layer is made of a non-conductive material.

13. The method of claim 9, wherein the waved sidewalls of the pixel-defining layer is formed by an exposure process and a development process, wherein the exposure process uses a standing wave effect produced by an light beam to expose the pixel-defining layer, and the development process then develops the pixel-defining layer to form the pattern.

14. The method of claim 9, wherein the pattern of the sidewall of the pixel-defining layer is saw-toothed.

15. The method of claim 9, wherein the pattern of the sidewall of the pixel-defining layer is undulated.

16. The method of claim 9, wherein the pattern of the sidewall of the pixel-defining layer is irregular.

17. An organic electroluminescent panel, comprising:
a substrate;
a first electrode formed on the substrate;
a pixel-defining layer with waved sidewalls disposed on the first electrode or on the substrate;
an organic functional layer disposed on the first electrode; and
a second electrode disposed on the organic functional layer.

18. The organic electroluminescent panel of claim 17, wherein the pixel-defining layer is non-conductive.

19. The organic electroluminescent panel of claim 18, wherein the pixel-defining layer is a photoresist.

20. The organic electroluminescent panel of claim 19, wherein the photoresist is photosensitive polyimide.

21. The organic electroluminescent panel of claim 19, wherein the photoresist is photosensitive diazonaphtho-quinone-phenolicresin.
